(19) United States
(12) Patent Application Publication
(10) Pub. No.: US 2016/0091099 A1
(43) Pub. Date: Mar. 31, 2016

(54) DIAPHRAGM VALVE

(71) Applicant: Buerkert Werke GmbH, Ingelfingen (DE)

(72) Inventors: Ralf SCHEIBE, Garnsberg/Kuenzelsau (DE); Cricia DE CARVALHO RODEGHERI, Mainz (DE); Peter KRIPPNER, Karlsruhe (DE); Stefan SEELECKE, Saarbruecken (DE)

(21) Appl. No.: 14/864,093

(22) Filed: Sep. 24, 2015

(30) Foreign Application Priority Data
Sep. 30, 2014 (DE) 102014114212.8

(51) Int. Cl. F16K 7/12; F16K 31/02; F16K 11/02

(52) U.S. Cl. CPC F16K 7/12; F16K 11/022; F16K 31/02

(57) ABSTRACT

There is described a diaphragm valve (10) comprising a housing (12) which includes at least two fluid openings (22, 24, 26), at least one valve seat (28, 30), a valve element (32), and at least one actuator (38). The actuator (38) is an electroactive polymer actuator which is able to shift the valve element (32) in order to release and/or close the at least one valve seat (28, 30).

### FIELD OF THE INVENTION

This invention relates to a diaphragm valve with which fluid streams can be controlled or switched.

### BACKGROUND

In the prior art, diaphragm valves are known in different constructions. They are characterized in that a valve element is provided, which controls the flow of a fluid through the valve by releasing or closing an associated valve seat. The valve element of a diaphragm valve typically is shifted by an actuator, in order to release or close the flow via the valve seat. In the prior art, electromagnetic actuators usually are employed, which include a coil. As compared to other valve types, diaphragm valves furthermore are characterized in that the actuator is not media-contacted, the valves have less dead space volume and can be rinsed more easily. Therefore, diaphragm valves are used in particular in the field of analysis technology.

In the known diaphragm valves it was found to be disadvantageous that the actuator also takes up energy in the stationary state, which is why the energy consumption of the known diaphragm valves generally is high. For example, the coil of an electromagnetic actuator must be excited permanently for the electromagnetic actuator to remain in its position. In addition, due to the usually ferromagnetic coils such diaphragm valves are not suitable for applications in the region of strong magnetic fields.

It is the object of the invention to provide a diaphragm valve which on the one hand has a low energy consumption and in addition is suitable for applications with strong magnetic fields.

### SUMMARY

According to the invention, this object is solved by a diaphragm valve comprising a housing which includes at least two fluid openings, at least one valve seat, one valve element and at least one actuator, wherein the actuator is an electroactive polymer actuator which is able to shift the valve element in order to release and/or close the at least one valve seat.

The idea underlying the invention is to form the diaphragm valve with an energy-efficient actuator. An electroactive polymer actuator includes two flexible electrodes between which a substantially incompressible polymer layer is arranged, for example an incompressible elastomer. A voltage can be applied to the two flexible electrodes whereby an electric field is built up between the two electrodes so that they attract each other. The incompressible polymer arranged inbetween thereupon expands perpendicularly to the field direction of the electric field formed between the two electrodes. This is due to the fact that the volume of the polymer must remain constant due to its incompressibility. As a reaction to being compressed in the one direction, the polymer therefore expands in a direction perpendicularly thereto. The displacement of the polymer between its initial state and its compressed state is used for shifting the valve element in order to correspondingly switch the diaphragm valve. Due to the design of the diaphragm valve either one fluid, for example in a 2/2-way valve or a 3/2-way valve, or several fluids can be switched, for example in a 3/3-way valve or a 5/3-way valve. Only very little energy is required for shifting the diaphragm valve since the electroactive polymer actuator is very efficient. In general, an electroactive polymer actuator requires no energy in the stationary state except for compensating leakage currents, as it is formed similar to a capacitor. In this way, a particularly energy-saving diaphragm valve is created which is formed as energy-saving proportional valve. The electroactive polymer actuator furthermore includes no ferromagnetic material which is why the diaphragm valve formed in this way is basically suitable for use with strong magnetic fields, for example in an MRT.

One aspect of the invention provides that the valve element is formed flexible, in particular is a diaphragm. The valve element thereby can be shifted only in part so that in general a single valve element and several actuators can be provided. Furthermore, several switching positions of the diaphragm valve thus can be realized via a single valve element.

Another aspect of the invention provides that the valve only includes components of non-ferromagnetic material. As a result, not only the actuator is formed for magnetic high-field applications, but the entire diaphragm valve. Such diaphragm valve therefore is suitable for use in an MRT. It also is possible that the diaphragm valve can be used for controlling ferromagnetic fluids.

Furthermore, the housing can include a first housing part and a second housing part, wherein the at least one valve seat and the at least two fluid openings are formed in the first housing part and the actuator is arranged in the second housing part. The diaphragm valve thus is divided into different portions, wherein one portion of the diaphragm valve is traversed by the fluid to be controlled.

In particular, the first and the second housing part are two housing halves, wherein the valve element is arranged, preferably clamped in part, between the two housing halves. In this way a particularly compact diaphragm valve is created which merely consists of two housing halves in which all components required for controlling the fluid are accommodated. The valve element separates the fluid-traversed portion of the diaphragm valve from the remaining portion of the diaphragm valve. Via the clamping of the valve element a predefined flexibility of the valve element can be adjusted. The overall height of such diaphragm valve is very small as compared to diaphragm valves with an electromagnetic actuator.

The actuator in particular can be a stack or diaphragm actuator. In this way, a higher shifting stroke of the actuator can be achieved with constant operating voltage applied.

Another aspect of the invention provides that on an inner wall of the housing at least one electric line is arranged, in particular integrated, via which the at least one actuator is coupled with an electric terminal. The at least one electric line can be electric conductor paths and/or a printed circuit board. The supply of the electroactive polymer actuator thus is effected directly in the housing, in particular in the second housing part. Accordingly, the electric line is provided in the portion of the diaphragm valve through which the fluid does not flow.

According to another aspect of the invention a spring element is provided which is arranged on the housing. Via the spring element, assembly tolerances of the diaphragm valve can be compensated. Furthermore, the spring element can be used to pretension the actuator so as to influence the stroke path proceeding from the same.

In particular, the spring element acts directly on the valve element. The actuator thereby can be pretensioned indirectly via the valve element on which the actuator is arranged directly,

Furthermore, the spring element also can act directly on the actuator, provided that the actuator is a diaphragm actuator.

Another aspect of the invention provides an adjusting device on the housing, via which the spring travel of the spring element can be adjusted. Via the adjusting device the closing force of the actuator can be adjusted and/or subsequently be adapted.

The adjusting device can be a receptacle with an adjusting screw which acts on the spring element. This represents a simple embodiment of the adjusting device so that a user of the diaphragm valve can adapt the closing force of the actuator with simple means.

According to another aspect of the invention, the housing includes three fluid openings and two valve seats, wherein one of the three fluid openings is an outflow opening which in particular is arranged centrally between the two other fluid openings. The two other fluid openings can represent inflow openings via which a fluid can each be supplied to the diaphragm valve. Thus, the diaphragm valve for example can be formed as 3/2-way valve or as 3/3-way valve. The diaphragm valve thus can be charged with two different fluids at the same time, which can flow out of the diaphragm valve via a common outflow opening.

In particular, the housing includes a mixing chamber which is in flow connection with the fluid openings. In the mixing chamber, the fluids supplied to the diaphragm valve can be mixed whereby selective mixing is possible within the diaphragm valve.

According to another aspect of the invention there are provided two actuators which can shift the valve element, wherein in particular the two actuators each are arranged directly opposite a valve seat. Due to the two actuators, the diaphragm valve has higher switching frequencies. In addition, a compact construction is possible since the forces exerted by the actuators are exerted directly on the valve element and the associated valve seat. A redirection of the forces proceeding from the actuators is not necessary.

The second actuator likewise can be an electroactive polymer actuator. The energy consumption of the diaphragm valve is very low despite the two actuators. Furthermore, the diaphragm valve also can be used for magnetic high-field applications.

Furthermore, a voltage can be applied to the two actuators in opposite directions. In this way, an active positioning movement and an active return movement of the valve element are realized. This reduces the hysteresis effects of the system. Furthermore, the efficiency of the diaphragm valve is increased and the response behavior of the diaphragm valve is improved.

According to another aspect of the invention a rocker is provided which is arranged in the housing and between the at least one actuator and the valve element, in this way a diaphragm valve can be formed which includes several supply lines which are actuated via a single actuator.

Furthermore, the two actuators can be coupled directly with the rocker and in particular act upon the rocker at two opposite ends. The diaphragm valve thereby is designed particularly stiff since the rocker is clamped by the actuators. Due to the stiff design, occurring flow changes and vibrations of the fluid have less impact on the control and regulation accuracy. The flow changes and vibrations are effectively suppressed by the stiff diaphragm valve. This generally increases the control and regulation accuracy.

Further advantages and properties of the invention can be taken from the following description and the drawings to which reference is made. In the drawings:

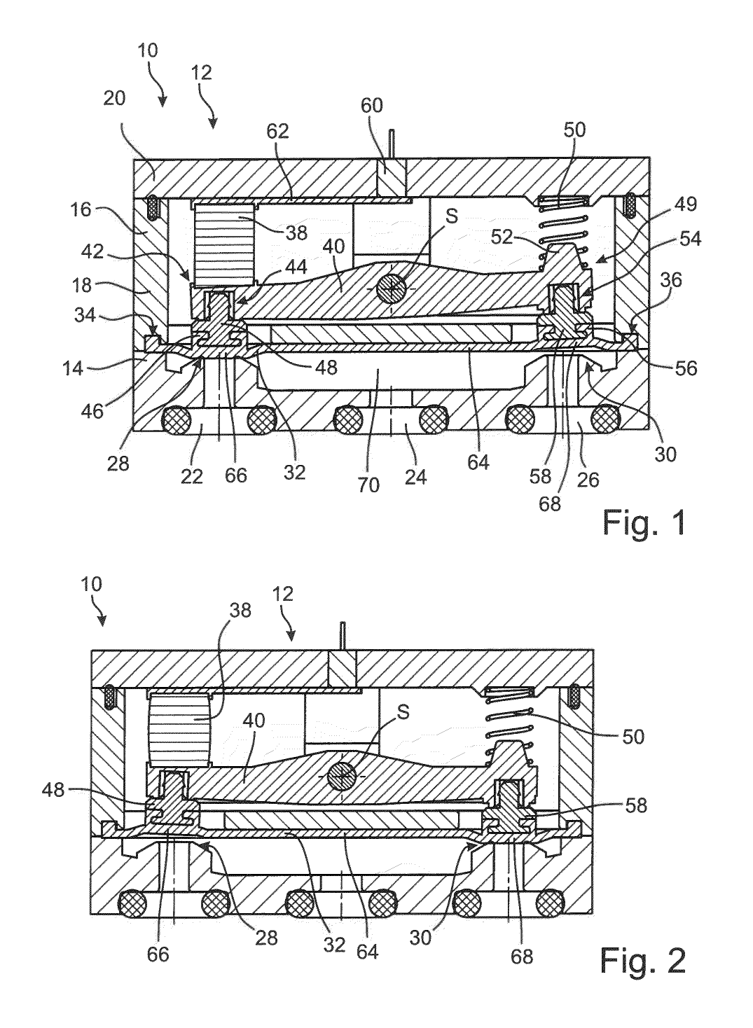

FIG. 1 shows a diaphragm valve of the invention according to a first embodiment in a first switching position,

FIG. 2 shows the diaphragm valve of FIG. 1 in a second switching position,

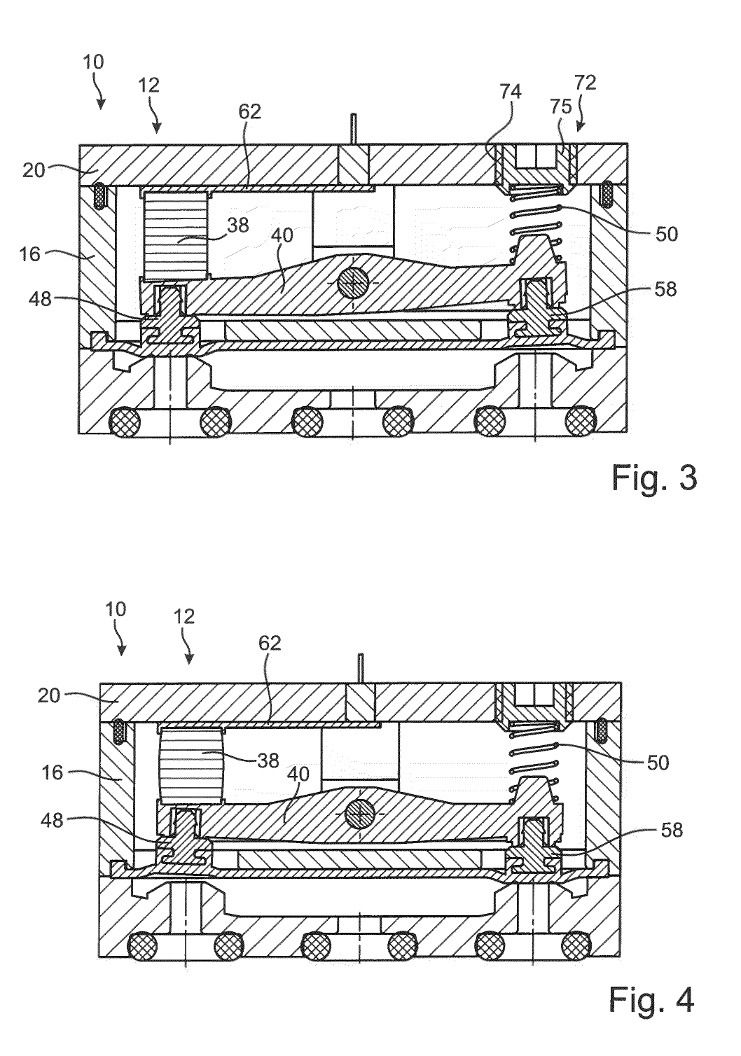

FIG. 3 shows a diaphragm valve of the invention according to a second embodiment in a first switching position,

FIG. 4 shows the diaphragm valve of FIG. 3 in a second switching position,

FIG. 5 shows a diaphragm valve of the invention according to a third embodiment in a first switching position,

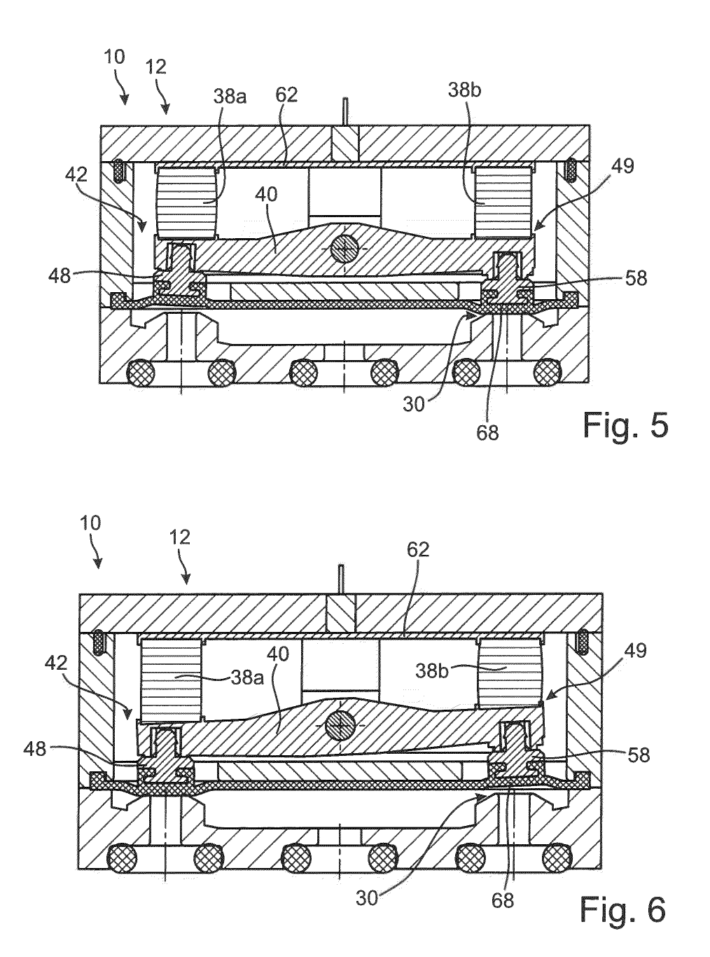

FIG. 6 shows the diaphragm valve according to FIG. 5 in a second switching position,

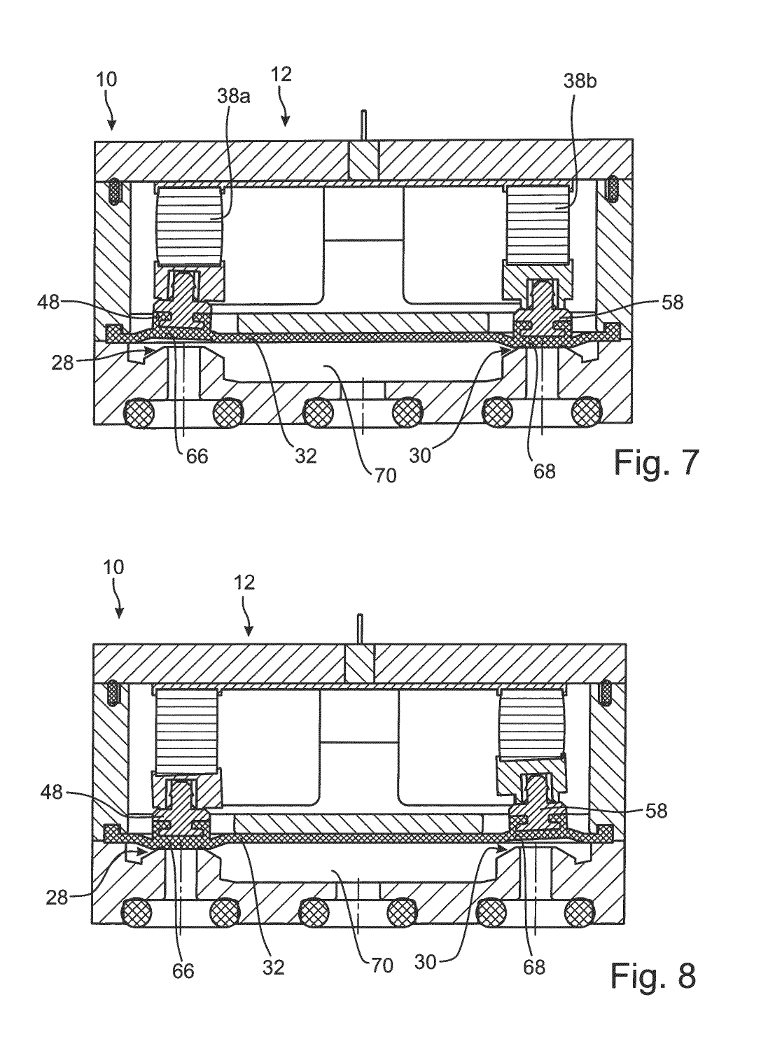

FIG. 7 shows a diaphragm valve of the invention according to a fourth embodiment in a first switching position,

FIG. 8 shows the diaphragm valve of FIG. 7 in a second switching position,

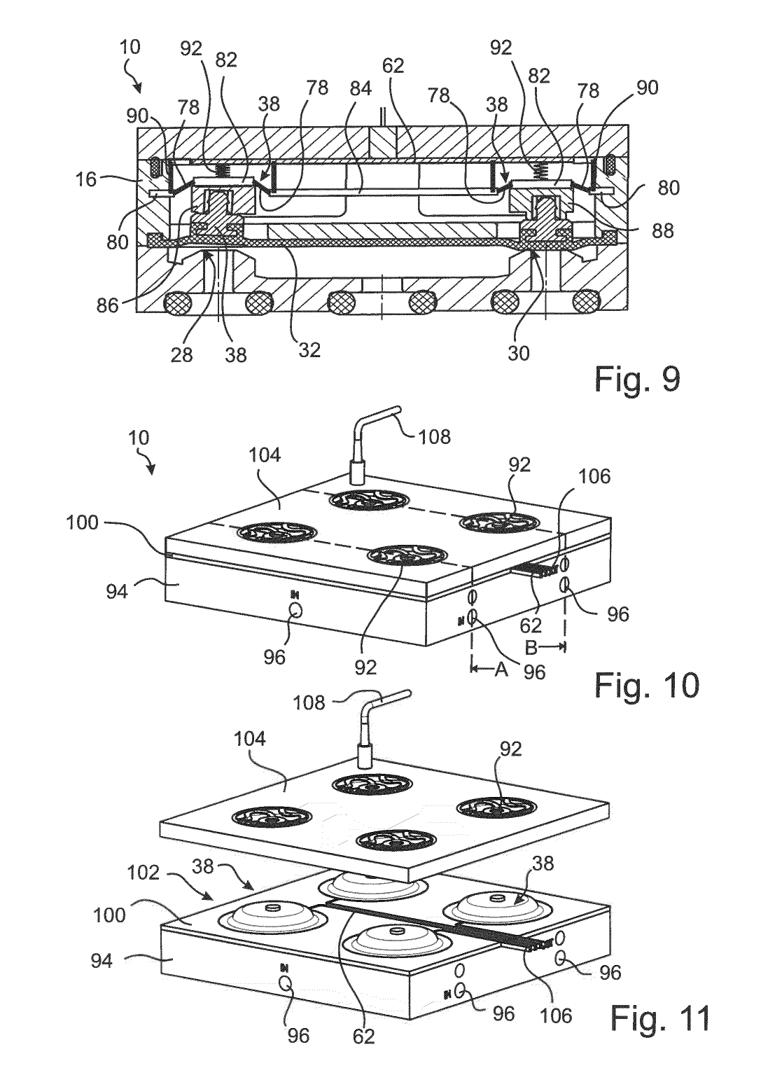

FIG. 9 shows a diaphragm valve of the invention according to a fifth embodiment in a second switching position,

FIG. 10 shows a diaphragm valve of the invention according to a sixth embodiment in a perspective view,

FIG. 11 shows the diaphragm valve of FIG. 10 with the lid removed,

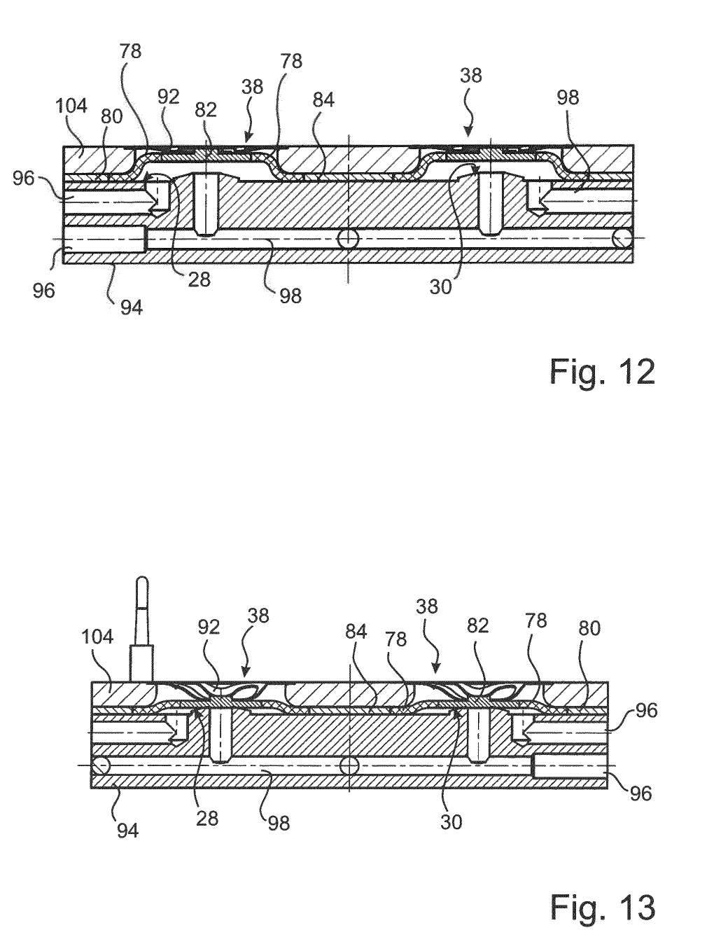

FIG. 12 shows the diaphragm valve of FIG. 10 in a first sectional view in which a first switching position is shown, and

FIG. 13 shows the diaphragm valve of FIG. 10 in a second sectional view in which a second switching position is shown.

### DETAILED DESCRIPTION OF THE DRAWINGS

FIG. 1 shows a diaphragm valve 10 according to a first embodiment in a first switching position. The diaphragm valve 10 has a housing 12 which is formed of a first housing part 14 and a second housing part 16. The second housing part 16 includes a sleeve-like portion 18 and a lid 20. The two housing parts 14, 16 generally represent two housing halves of the entire housing 12 of the diaphragm valve 10.

In the first housing part 14 three fluid openings 22, 24, 26 are formed. For better distinguishability the fluid openings 22, 24, 26 are referred to as first inflow opening 22 and second inflow opening 26, via which a fluid can be supplied to the diaphragm valve, and as outflow opening 24 via which fluid can flow out of the diaphragm valve 10. The outflow opening 24 is arranged centrally between the two inflow openings 22, 26. The fluid openings 22 to 26 generally are surrounded by a sealing ring.

To the two inflow openings 22, 26 a first valve seat 28 and a second valve seat 30 each is associated, which are formed within the housing 12. The two valve seats 28, 30 cooperate with a valve element 32 which in the illustrated embodiment is formed flexible. The valve element 32 is a diaphragm which is clamped between the first housing part 14 and the second housing part 16. By means of such clamping, the flexible valve element 32 can be pretensioned, so that a certain force is required for shifting the valve element 32.

The second housing part 16 furthermore includes undercut cutouts 34, 36 in which the valve element 32 is inserted with an edge portion so that the valve element 32 safely is accommodated between the two housing parts 14, 16.

The two undercut cutouts 34, 36 also can be formed as a circumferential, undercut groove of the housing 12.

The valve element 32 which cooperates with the two valve seats 28, 30 is shifted via an actuator 38 in the illustrated embodiment. The actuator 38 is an electroactive polymer actuator which in the illustrated embodiment is formed as stack actuator. In particular, the actuator 38 can be a dielectric electroactive polymer actuator.

The electroactive polymer actuator 38 in particular is formed as stack actuator in which several polymer and electrode layers are stacked alternately on top of each other, in the stack actuator an incompressible polymer each is arranged between two flexible electrodes, which in particular is dielectric. By applying a voltage to the two electrodes an electric field is formed so that the two electrodes attract each other. The incompressible polymer arranged inbetween thereby is compressed, wherein due to its incompressibility it expands perpendicularly to the field direction. The compression of the polymer layers effected parallel to the field direction is utilized to provide a stroke travel along the electroactive polymer actuator 38 so that the same can act as actuator.

The electroactive polymer actuator 38 is similar to a capacitor since two electrodes are provided which can store an applied electric energy. This means that an electroactive polymer actuator 38 once shifted does not require any further supply of energy in order to maintain its stationary state. It is merely necessary to compensate leakage currents in order to maintain the voltage between the two electrodes.

As can be seen in FIG. 1, the actuator 38 is arranged between the second housing part 16 and a rocker 40 which is pivotally mounted about a swivel axis S.

At a first end 42 the rocker 40 includes a first coupling region 44 via which the rocker 40 is firmly coupled with the valve element 32. For this purpose, the valve element 32 includes a first coupling portion 46 in which a first coupling element 48 is accommodated which cooperates with the first coupling region 44 in order to form a firm connection with the rocker 40.

The actuator 38 is arranged at the first end 42 of the rocker 40 so that the actuator 38 on the one hand can exert a moment as high as possible on the rocker 40 and on the other hand is arranged directly opposite the first valve seat 28. In a first, non-activated state the actuator 38 is arranged mechanically pretensioned between the second housing part 16 and the rocker 40 and acts directly vertically on the valve element 32 in order to be able to close the first valve seat 28.

At the second end 49 of rocker 40 a spring element 50 is provided which cooperates with a protrusion 52 on the rocker 40 and likewise supports on the second housing part 16. The spring element 50 is arranged opposite the second valve seat 30.

At the second end 49, the rocker 40 is coupled with the valve element 32 via a second coupling region 54, a second coupling portion 56 of the valve element 32, and a second coupling element 58.

The two coupling elements 48, 58 are formed as pin-shaped elements with disk portions which are inserted into corresponding cutouts in the coupling portions 46, 56.

In FIG. 1 the spring element 50 is compressed so that the second valve seat 30 is opened.

The electroactive actuator 38 receives its operating voltage via a connector 60 which is arranged centrally in the second housing part 16, in particular in the lid 20. From the connector 60, electric lines 62 in the form of a printed circuit board and/or in the form of conductor paths extend to the actuator 38 in order to form an electric connection with the connector 60. The electric lines 62 can be arranged on the second housing part 16 or even be integrated into the same.

Furthermore, an abutment web 64 is formed in the housing 12, against which the valve element 32 substantially rests. By means of the abutment web 64 it is achieved that when switching the diaphragm valve 10, only a first diaphragm portion 66 of the valve element 32 is shifted via the actuator 38 or a second diaphragm portion 68 of the valve element 32 is shifted via the spring element 50. These two diaphragm portions 66, 68 are the portions of the valve element 32 which are located directly opposite the respective valve seats 28, 30. In this way, an efficient diaphragm valve 10 is formed.

Furthermore, a mixing chamber 70 is formed in the diaphragm valve 10, the mixing chamber being aligned directly with the outflow opening 24. The two inflow openings 22, 26 likewise are in fluidic connection with the mixing chamber 70, provided that the position of the diaphragm valve 10 permits a fluid connection. In the mixing chamber 70, two different fluids can be mixed with each other.

The mode of operation of the diaphragm valve 10 is as follows:

In a first, non-activated position or starting position, the actuator 38 for example is in a non-deflected position which is shown in FIG. 1.

Under mechanical pretension, the actuator 38 extends towards the first valve seat 28. The actuator 38 thereby on the one hand acts on the first diaphragm portion 68 against the spring force of the spring 50 in order to close the first valve seat 28. On the other hand, the actuator 38 also acts on the rocker 40 so that the same is pivoted about the swivel axis S.

By pivoting the rocker 40, the second diaphragm portion 68 at the same time is lifted from the second valve seat 30 so that a fluid connection is produced via the second inflow opening 26 into the mixing chamber 70.

The diaphragm valve 10 can be held in this initial switching position without energy consumption.

FIG. 2 shows the diaphragm valve 10 of FIG. 1 in a second, activated switching position.

A voltage is applied to the polymer actuator 38 via the at least one electric line 62 shown here. The substantially incompressible polymer thereby expands perpendicularly to the electric field formed between the electrodes, whereby the polymer actuator 38 is compressed. The spring element 50 is compressed less and the rocker 40 is pivoted about the swivel axis S in the other direction. The first diaphragm portion 66 thereby is lifted and the first valve seat 28 is cleared.

Via the spring element 60 the second diaphragm portion 68 is shifted at the same time such that it blocks the second valve seat 30.

A comparison of FIGS. 1 and 2 reveals that the valve element 32 mainly rests against the abutment web 64 so that it is not shifted in this region.

The Figures shown are sectional drawings which is why the diaphragm valve 10 generally has a second electric line with a second pin.

FIGS. 3 and 4 show the diaphragm valve 10 according to a second embodiment.

The second embodiment of the diaphragm valve 10 differs from the first embodiment in that an adjusting device 72 is provided which is arranged in the second housing part 16, in particular in the lid 20.

The adjusting device 72 includes a receptacle 74 which is arranged in the region of the spring element 50. Through the receptacle 74 an adjusting screw 75 can be screwed in, which adjusts the spring travel of the spring element 50. In this way, a subsequent adaptation of the setting of the spring travel or the closing force can be made.

FIGS. 5 and 6 show the diaphragm valve 10 according to a third embodiment, which differs from the first embodiment in that two actuators 38a, 38b are provided which both are formed as electroactive polymer actuators.

The second electroactive polymer actuator 38b has replaced the spring element 50 provided in the first embodiment. The electric lines 62 provided on the second housing part 16 now extend from the first actuator 38a to the second actuator 38b whereby in general a symmetric construction of the diaphragm valve 10 is achieved.

The second actuator 38b accordingly cooperates with the second end 49 of the rocker 40 in order to be able to shift the second diaphragm portion 68 such that the same releases or closes the second valve seat 30. The second actuator 38b for this purpose is arranged directly opposite the second valve seat 30.

Due to the two actuators 38 higher switching frequencies of the diaphragm valve 10 can generally be achieved.

Furthermore, the rocker 40 can be clamped by the two actuators 38 which each are arranged at opposite ends 42, 49 of the rocker 40. In this way, a stiff regulating system of the diaphragm valve 10 is formed, which is able to balance or compensate flow fluctuations of the fluid supplied to the diaphragm valve 10.

FIGS. 7 and 8 show the diaphragm valve 10 according to a fourth embodiment which differs from the third embodiment in that no rocker 40 is provided.

The two actuators 38 cooperate directly with the valve element 32 or the corresponding diaphragm portions 66, 68. It is only that the coupling elements 48, 58 are provided for coupling of the actuators 38 with the valve element 32.

The fourth embodiment of the diaphragm valve 10 is characterized in that due to the omission of the rocker 40 several switching positions can be achieved since the two actuators 38 independently can lift the associated diaphragm portion 66, 68 from the respective valve seat 28, 30 or press it on the respective valve seat 28, 30.

With the diaphragm valve 10 as shown in the fourth embodiment it thus also is possible to release both valve seats 28, 30 at the same time by simultaneously activating both actuators 38, whereby the mixing chamber 70 can be rinsed or be filled with different fluids at the same time. With the fourth embodiment of the diaphragm valve 10 it furthermore is possible to close both valve seats 28, 30 at the same time.

In the embodiments of the diaphragm valve 10 in which two actuators 38 are provided, it can be provided in particular that these two actuators 38 are charged with a voltage in opposite directions. Active shifting and resetting of the valve element 32 thereby can be realized so that the hysteresis of the diaphragm valve 10 is reduced. As a result, an efficient diaphragm valve 10 is formed which has a better response behavior.

FIG. 9 shows a fifth embodiment of the diaphragm valve 10 according to the invention.

This embodiment differs from the above-described embodiments in the formation of the actuators 38. Identical elements or elements with the same effect are provided with the same reference numerals.

In the fifth embodiment the actuators 38 are formed as diaphragm actuators. The diaphragm actuators likewise are electroactive polymer actuators which at least have an active polymer portion 78. If several active polymer portions 78 are provided, the same are not arranged in the form of a stack.

The embodiment shown in FIG. 9 reveals that an actuator 38 formed as diaphragm actuator includes several active polymer portions 78 which are arranged between carrier parts 80, 82 and 84 of the diaphragm actuators. The carrier parts 80 to 84 in particular can be formed rigid.

The first carrier part 80 is arranged on a side wall of the second housing part 16, in particular accommodated in the side wall. A first active polymer portion 78 extends from the first carrier part 80 to a second carrier part 82 which is coupled with a first coupling part 86. The first coupling part 86 in turn is coupled with the first coupling element 38 which cooperates with the valve element 32. When the first carrier part 82 is shifted, this shifting movement thus is transmitted to the valve element 32. The first coupling part 86 thus is functionally equivalent to the first coupling region 44 of the rocker 40 according to the diaphragm valve 10 of the embodiments described above.

From the second carrier part 82, an active polymer portion 78 in turn extends, which connects the second carrier part 82 with the third carrier portion 84 so that the second carrier part 82 is coupled with an active polymer portion 78 on both opposite sides. It thereby is ensured that the second carrier part 82 is shifted uniformly and substantially perpendicularly to its direction of expansion.

At the opposite end, the third carrier part 84 in turn is coupled with an active polymer portion 78 which is part of the other actuator 38, which correspondingly comprises a second coupling part 88 in order to act on the valve element 32.

The two actuators 38 thus have a common carrier part 84 which is why the two actuators 38 also can be regarded as actuator vector or actuator matrix, which is formed symmetrically.

Contacting of the actuators 38 formed as diaphragm actuators is effected via contacts 90, which in the illustrated embodiment are formed as contact pins which are provided laterally at the second housing part 16. The contacts 90 are connected with the electric lines 62 so that the signal fed in via the electric lines 62 can be transmitted to the contacts 90 and the actuators 38.

In general, the two actuators 38 formed as diaphragm actuators are actuatable separately just like the stack actuators described above.

Furthermore, a spring element 92 each is associated with the two actuators 38 formed as diaphragm actuators, which directly cooperates with the actuators 38.

In the position of the diaphragm valve 10 as shown in FIG. 9, the second valve seat 30 is dosed by the associated non-activated actuator 38 and the spring element 92 cooperating with the same, whereas the first valve seat 28 is opened by the associated activated actuator 38 and the spring element 92 formed as tension spring.

The mode of operation of the diaphragm valve 10 otherwise is analogous to the embodiments described above.

A sixth embodiment of the diaphragm valve 10 according to the invention is shown in FIGS. 10 to 14.

This embodiment of the diaphragm valve 10 differs from the preceding embodiments in that several actuators 38 are provided which are arranged in the form of a matrix.

The housing 12 comprises a fluid channel plate 94 with ports 96 via which a fluid can be fed into fluid channels 98 (see FIGS. 12 and 13) which form the flow channels of the diaphragm valve 10.

On the fluid channel plate 94 a carrier 100 is arranged which includes the actuators 38. The actuators 38 in particular can be integrated in the carrier 100. The actuators 38 can be diaphragm actuators analogous to the fifth embodiment.

In general, the carrier 100 and the actuators 38 arranged thereon constitute an actuator matrix 102, i.e. an arrangement of actuators 38 which are arranged in an element formed as base body, here the carrier 100. In the embodiment shown, two actuators 38 are provided in one line and two actuators 38 are provided in one column so that the actuator matrix 102 shown here includes 2×2 actuators 38 (see FIG. 11).

In the embodiment shown, the carrier 100 is plate-shaped so that it forms a carrier plate. The carrier 100 in general or the concrete carrier plate can be formed as diaphragm, in particular as elastomer diaphragm, which includes the polymer actuator regions 78.

Alternatively, a diaphragm can be arranged between the carrier 100 and the fluid channel plate 94 which separates the media-contacted region from the actuator region.

The housing 12 furthermore comprises a lid 104 which is put onto the carrier 100 in order to form a termination of the housing 12. The lid 104 in particular can be fabricated plate-shaped and/or from metal.

Furthermore, the lid 104 correspondingly includes a spring element 92 for each actuator 38, which analogous to the fifth embodiment cooperate with the actuators 38 or are connected with the same. The spring elements 92 of the sixth embodiment are shaped spring contours which preferably have been incorporated into the lid 104 by an etching method. The spring elements 92 accordingly are formed integrally with the lid 104.

FIG. 11 furthermore shows that the electric lines 62 are arranged in the carrier 100 which electrically couple the individual actuators 38 with each other. The electric lines 62 include first terminals 106 which for example are formed as positive terminal. Furthermore, a second terminal 108 is provided which correspondingly is formed as negative terminal or ground terminal so that the actuators 38 can be supplied with voltage. In the illustrated embodiment, the negative terminal is realized via the spring elements 92 and the lid 104 which in the exemplary embodiment are formed metallic.

FIGS. 12 and 13 show sectional views along the sectional lines A and B as shown in FIG. 10, wherein the actuators 38 in FIG. 12 are in an activated position so that they release the corresponding valve seats 28, 30. On the other hand, the actuators 38 in FIG. 13 are in a non-activated position since the valve seats 28, 30 are dosed, so that the fluid cannot flow through the fluid channels 98 associated to the actuators 38.

In the embodiment shown, each row of the actuator matrix 102 thus includes a first and a second valve seat 28, 30.

The mode of operation of the actuators 38 is analogous to that of the actuators 38 in the fifth embodiment since the actuators 38 formed as diaphragm actuators in turn include the three carrier parts 80 to 84 and the active polymer portions 78 which are arranged between the respective carrier parts 80 to 84 and are electrically excited.

For reasons of better representability, the electric terminals of the polymer portions 78 are not shown.

In general, the individual actuators 38 can be actuated individually so that several switching positions of the diaphragm valve 10 can be achieved. Furthermore, the actuator matrix 102 can comprise more than the four actuators 38 shown. Correspondingly, each row of the actuator matrix 102 includes more than two valve seats.

In all illustrated embodiments the used components, in particular the housing 12, the optional rocker 40 and the coupling elements 48, 58 can be made of a plastic material or an a magnetic metal. As a result, no ferromagnetic materials are used in the diaphragm valve 10 so that the same is suitable for magnetic high-field applications, for example an MRT. For example, the components can be injection-molded parts.

Furthermore, ferromagnetic fluids can be controlled with such type of diaphragm valve 10.

According to the invention, an energy-efficient diaphragm valve 10 thus is created, which in the stationary state has no energy consumption.

1. A diaphragm valve comprising a housing which includes at least two fluid openings, at least one valve seat, one valve element and at least one actuator, wherein the actuator is an electroactive polymer actuator which is able to shift the valve element in order to release and/or close the at least one valve seat.

2. The diaphragm valve according to claim 1, characterized in that the valve element is formed so as to be a flexible diaphragm.

3. The diaphragm valve according to claim 1, characterized in that the diaphragm valve only includes components of non-ferromagnetic material.

4. The diaphragm valve according to claim 1, characterized in that the housing includes a first housing part and a second housing part, wherein the at least one valve seat and the at least two fluid openings are formed in the first housing part and the actuator (38) is arranged in the second housing part (16).

5. The diaphragm valve according to claim 4, characterized in that the first housing part and the second housing part are housing halves, with the valve element being arranged between the two housing halves.

6. The diaphragm valve according to claim 1, characterized in that the actuator is a stack or diaphragm actuator.

7. The diaphragm valve according to claim 1, characterized in that on an inner wall of the housing at least one electric line is arranged via which the at least one actuator is coupled with an electric terminal.

8. The diaphragm valve according to claim 1, characterized in that a spring element is provided, which is arranged on the housing and directly acts on the valve element.

9. The diaphragm valve according to claim 8, characterized in that on the housing an adjusting device is provided via which the spring travel of the spring element can be adjusted.

10. The diaphragm valve according to claim 9, characterized in that the adjusting device is a receptacle with an adjusting screw which acts on the spring element.

11. The diaphragm valve according to claim 1, characterized in that the housing includes three fluid openings and two valve seats, wherein one of the three fluid openings is an outlet opening arranged centrally between the two other fluid openings.

12. The diaphragm valve according to claim 11, characterized in that in the housing a mixing chamber is formed which is in flow connection with the fluid openings.

13. The diaphragm valve according to claim 1, characterized in that two actuators are provided which are able to shift the valve element, wherein the two actuators are each are arranged directly opposite a valve seat.

14. The diaphragm valve according to claim 13, characterized in that each of the two actuators is an electroactive polymer actuator.

15. The diaphragm valve according to claim 14 characterized in that a voltage is applied to the two actuators in opposite directions.

16. The diaphragm valve according to claim 1, characterized in that a rocker is provided which is arranged in the housing and between the at least one actuator and the valve element.

17. The diaphragm valve according to claim 13, characterized in that a rocker is provided which is arranged in the housing and between at least one actuator and valve element and that the two actuators are directly coupled with the rocker and act on the rocker at two opposite ends.

18. The diaphragm valve according to claim 1, comprising a housing which includes a first housing part and a second housing part, at least two fluid openings located in the first housing part, at least one valve seat, one valve element formed so as to be a flexible diaphragm and arranged between the first housing element and the second housing element, and at least one stack or diaphragm actuator arranged in the second housing part, wherein the at least one actuator is an electroactive polymer actuator which is able to shift the valve element in order to release and/or close the at least one valve seat, wherein the diaphragm valve only includes components of non-ferromagnetic material.

19. The diaphragm valve according to claim 18, characterized in that on an inner wall of the housing at least one electric line is arranged via which the at least one actuator is coupled with an electric terminal.

20. The diaphragm valve according to claim 18, characterized in that a spring element is provided, which is arranged on the housing and directly acts on the valve element.

21. The diaphragm valve according to claim 20, characterized in that on the housing an adjusting device is provided via which the spring travel of the spring element can be adjusted.

22. The diaphragm valve according to claim 21, characterized in that the adjusting device is a receptacle with an adjusting screw which acts on the spring element.

23. The diaphragm valve according to claim 18, comprising three fluid openings located in the first housing part and characterized in that in the housing a mixing chamber is formed which is in flow connection with the fluid openings.

24. The diaphragm valve according to claim 18, characterized in that two electroactive polymer actuators are provided which are able to shift the valve element, wherein the two actuators are each are arranged directly opposite a valve seat.

25. The diaphragm valve according to claim 18 characterized in that a rocker is provided which is arranged in the housing and between the at least one actuator and the valve element.

26. The diaphragm valve according to claim 24, characterized in that a rocker is provided which is arranged in the housing and between at least one actuator and valve element and that the two actuators are directly coupled with the rocker and act on the rocker at two opposite ends.
